(19) United States
(12) Patent Application Publication
(10) Pub. No.: US 2025/0311030 A1
(43) Pub. Date: Oct. 2, 2025

(54) METHOD AND SYSTEM TO PAIR AND POSITION WIRELESS NODES BY IMAGE RECOGNITION

(71) Applicant: Shenzhen Litetrace Technologies CO., Ltd., Guangdong (CN)

(72) Inventor: Ming DENG, Guangdong (CN)

(73) Assignee: Shenzhen Litetrace Technologies CO., Ltd., Guangdong (CN)

(21) Appl. No.: 18/977,841

(22) Filed: Dec. 11, 2024

(30) Foreign Application Priority Data
Mar. 27, 2024 (CN) 202410366303.9

(51) Int. Cl. H04W 76/14; G06T 7/70; H04W 16/18

(52) U.S. Cl. CPC H04W 76/14; G06T 7/70; H04W 16/18

(57) ABSTRACT

The present invention relates to the field of Internet of Things (IoT) technology and discloses a method to pair and position wireless nodes by image recognition, comprising: Using a control center software to complete the positioning and pairing operations and enter the pairing information and/or the site plan; Capturing site images, completing anchor point adaptation, and circling a pairing range according to the images captured; Circling nodes to be paired within the pairing range, through wireless scanning by the control center, and creating the information list of nodes to be paired; Capturing site images of turned-on and turned-off lamps, recognizing the position of turned-on and turned-off lamps in the image, and obtaining the coordinate position list of the corresponding node according to the position of turned-on and turned-off lamps; Judging whether the node coordinate obtained falls within the node pairing range circled, by the control center.

### CROSS-REFERENCE TO RELATED APPLICATION

This application claims the priority benefit of China application serial no. 202410366303.9, filed on Mar. 27, 2024. The entirety of the above-mentioned patent application is hereby incorporated by reference herein and made a part of this specification.

### BACKGROUND

### Technical Field

The present invention relates to the field of Internet of Things (IoT) technology, in particular to a method and system to pair and position wireless nodes by image recognition, and in particular to technologies and products such as pairing and recognition of wireless IoT devices, and their application in the field of lighting control.

### Description of Related Art

Wireless IoT products shall be paired and positioned before use to facilitate realization of subsequent operations and business functions.

Pairing includes the pairing of a device node with a gateway (central node), or the pairing of a device node with an APP or application software. Usually in this process, operations such as network access, password distribution, and ID assignment are completed.

Current common pairing methods include paring by scanning the QR code, in which the pairing is completed by scanning the pre-printed bar code or QR code on the device through the camera, and recognizing it through software; physical pairing, in which it is necessary to press the physical keys, special pairing keys on the device in a set order or otherwise trigger the pairing mode; pairing by wireless airborne scanning and recognition, in which a wireless device node broadcasts the node information, and the gateway scans these node information to complete the pairing; and factory pre-pairing, in which the pairing is completed in advance during ex-factory.

These common pairing methods have their drawbacks, respectively. For example, the paring by scanning the QR code and physical pairing methods are cumbersome to operate, making it difficult to operate once the device is installed. The method of pairing by wireless airborne scanning and recognition makes it difficult to position the wireless device. Ex-factory pre-pairing is demanding in terms of early information collection, project planning, and later installation, making later modification difficult. In projects facing a large number of IoT nodes and devices, these drawbacks can be very significant, affecting the implementation cost, application, and promotion of the project.

Positioning refers to finding where the device node and the appliances controlled by the device node (e.g., lamps and air conditioners, etc.) are located to determine the operations that the device node can perform and the business functions that it provides. At present, the common device positioning methods in the market include manual positioning, in which manual recognition and positioning are completed through sound and light; positioning through satellite technologies such as GPS; and positioning assisted by wireless positioning technologies such as Bluetooth, WIFI, and UWB, etc.

The positioning methods of these scenes also have their drawbacks, respectively. For example, the manual positioning method is cumbersome to operate, which sets high technical requirements for operators and high labor costs, especially in projects with a large number of device nodes. GPS satellite positioning technology can only be applied to outdoor projects. Bluetooth, WIFI, UWB, and other wireless positioning technologies can be applied indoors, but they need the assistance of special base stations or special beacons, and the positioning accuracy is restricted by the indoor environment, so the overall application and promotion are greatly limited.

The drawbacks of these solutions above limit the promotion of wireless IoT technology solutions, affect the speed of pairing and positioning of wireless nodes, and increase the construction cost and time. Therefore there is an urgent need for a simpler and faster method to pair and position wireless nodes.

### SUMMARY

The present invention aims to provide a method and system to pair and position wireless nodes by image recognition to solve the technical problems above.

The present invention is implemented by a method to pair and position wireless nodes by image recognition, wherein the method to pair and position wireless nodes by image recognition includes the following steps:
S1. Using a control center software to complete the positioning and pairing operations and enter the pairing information and/or the site plan;
S2. Capturing site images, completing anchor point adaptation, and circling a pairing range according to the images captured;
S3. Circling nodes to be paired within the pairing range, through wireless scanning by the control center, and creating the information list of nodes to be paired;
S4. Capturing site images of turned-on and turned-off lamps, recognizing the position of turned-on and turned-off lamps in the image, and obtaining the coordinate position list of the corresponding node according to the position of turned-on and turned-off lamps;
S5. Judging whether the node coordinate obtained falls within the node pairing range circled, by the control center; if yes, sending the pairing information to the node to complete pairing; and if no, deleting the coordinate of the current node from the list; and
S6. Outputting the paired node information and coordinate information, and marking the information on the image and/or the site plan.

In a further technical solution of the present invention, the step S4 further includes the following steps:
S41. Obtaining the information on the next node from the list of nodes to be positioned;
S42. Judging whether the nodes to be positioned are all positioned; if yes, outputting the coordinate information list corresponding to the nodes; and if no, executing the next step;
S43. Sending the command of turning on and turning off lamps from a designated node to turn on and turn off lamps at the node, and capturing site images of turned-on lamps and site images of turned-off lamps;
S44. Recognizing the site images of turned-on lamps and site images of turned-off lamps obtained from the node and obtaining the position of lamps corresponding to the node; and
S45. Judging whether the position of lamps corresponding to the node falls within the node pairing range; if no, determining that the node does not fall within the pairing range and executing step S41; if yes, stretching and calibrating the image according to the pairing anchor points, calculating the coordinate position of the node on the calibrated image, recording the corresponding information and executing step S41.

In a further technical solution of the present invention, the step S5 further includes the following steps:
S51. Obtaining the information on the next node from the list of nodes to be paired;
S52. Judging whether all nodes in the list are all paired; if yes, outputting the information on the nodes that are paired successfully, marking them on the image and entering the marking points on the plan; and if no, executing the next step;
S53. Judging whether the coordinate of the current node falls within the pairing range; if yes, sending the pairing information to the current node, adding the node to a new pairing network, and executing the next step; and if no, skipping the current node and executing step S51; and
S54. Searching the current node in the new pairing network and judging whether the node is paired successfully; and if yes, recording the information on the current node.

In a further technical solution of the present invention, the step S54 further includes the following steps:
S541. Judging whether a site plan is entered; if yes, marking the position of the node on the plan, and proceeding the pairing process of the next node; and if no, skipping the process.

In a further technical solution of the present invention, the pairing information entered in the step S1 includes the name of the pairing network and the login password of the pairing network; and the entered information includes a site plan for subsequent pairing and output of the coordinate of the site plan.

In a further technical solution of the present invention, step S2 further includes the following steps:
S21. Marking several paired anchor points on the image and/or the site plan, respectively;
S22. Marking the scale of the coordinates on the paired image and/or the site plan; and
S23. Combining the anchor points and the coordinate positioning points, and circling the pairing range on the site plan and/or the image.

In a further technical solution of the present invention, the control center in the step S4 recognizes the position of nodes one by one and outputs the coordinate list of all nodes.

In a further technical solution of the present invention, the site images are captured by cameras; the capturing mode by cameras may be done by a single camera or capturing by a plurality of cameras, wherein the capturing by a plurality of cameras involves the use of a triangulation method for multiple positioning and averaging to reduce the angle error of the images captured and improve the accuracy; and the images captured are calibrated by an algorithm software.

In a further technical solution of the present invention, the node information includes MAC address, ID in the network and coordinate information; and the sending the pairing information includes the name of the network, the communication password, and the ID of the current node in the pairing network.

In a further technical solution of the present invention, recording the information of the current node if the node is paired successfully includes MAC address, ID, and node type in the new pairing network.

The present invention further aims to provide A system to pair and position wireless nodes by image recognition, wherein the system to pair and position wireless nodes by image recognition includes
a module to start the entering, for using a control center software to complete the positioning and pairing operations and enter the pairing information and/or the site plan;
a module to circle the range, for capturing site images, completing anchor point adaptation, and circling a pairing range according to the images captured;
a module to scan the node list, for circling nodes to be paired within the pairing range, through wireless scanning by the control center, and creating the information list of nodes to be paired;
a module to obtain the node coordinate, for capturing site images of turned-on and turned-off lamps, recognizing the position of turned-on and turned-off lamps in the image, and obtaining the coordinate position list of the corresponding node according to the position of turned-on and turned-off lamps;
a module to judge, for judging whether the node coordinate obtained falls within the node pairing range circled, by the control center; if yes, sending the pairing information to the node to complete pairing; and if no, deleting the coordinate of the current node from the list; and
a module to mark, for outputting the paired node information and coordinate information, and marking the information on the image and/or the site plan.

In a further technical solution of the present invention, the module to obtain the node coordinate further includes
a unit to obtain the next node, for obtaining the information on the next node from the list of nodes to be positioned;
a unit to judge the positioning, for judging whether the nodes to be positioned are all positioned; if yes, outputting the coordinate information list corresponding to the nodes; and if no, executing the unit to obtain the images of turned on and turned off lamps;
a unit to obtain the images of turned-on and turned-off lamps, for sending the command of turning on and turning off lamps from a designated node to turn on and turn off lamps at the node, and capturing site images of turned-on lamps and site images of turned off lamps;
a unit to obtain the position recognized, for recognizing the site images of turned-on lamps and site images of turned-off lamps obtained from the node and obtaining the position of lamps corresponding to the node; and
a unit to judge the node position, for judging whether the position of lamps corresponding to the node falls within the node pairing range; if no, determining that the node does not fall within the pairing range and executing the unit to obtain the next node; if yes, stretching and calibrating the image according to the pairing anchor points, calculating the coordinate position of the node on the calibrated image, recording the corresponding information and executing the unit to obtain the next node.

In a further technical solution of the present invention, the module to judge further includes
a unit to obtain the node information, for obtaining the information on the next node from the list of nodes to be paired;
a unit to complete pairing, for judging whether all nodes in the list are all paired; if yes, outputting the information on the nodes that are paired successfully, marking them on the image and entering the marking points on the plan; and if no, executing the unit to judge the coordinate point;
a unit to judge the coordinate point, for judging whether the coordinate of the current node falls within the pairing range; if yes, sending the pairing information to the current node, adding the node to a new pairing network, and executing the unit to record the judgment; and if no, skipping the current node and executing the unit to obtain the node information; and
a unit to record the judgment, for searching the current node in the new pairing network and judging whether the node is paired successfully; and if yes, recording the information on the current node.

In a further technical solution of the present invention, the unit to record the judgment further includes
a unit to judge the site plan entering, for judging whether a site plan is entered; if yes, marking the position of the node on the plan, and proceeding the pairing process of the next node; and if no, skipping the process

In a further technical solution of the present invention, the pairing information entered in the module to start the entering includes the name of the pairing network and the login password of the pairing network; and the entered information includes a site plan for subsequent pairing and output of the coordinate of the site plan.

In a further technical solution of the present invention, the module to circle the range further includes
a unit to mark the anchor points, for marking several paired anchor points on the image and/or the site plan, respectively;
a unit to mark the scale, for marking the scale of the coordinates on the paired image and/or the site plan; and
a unit to circle the pairing range, for combining the anchor points and the coordinate positioning points, and circling the pairing range on the site plan and/or the image.

In a further technical solution of the present invention, the control center in the module to obtain the node coordinate recognizes the position of nodes one by one and outputs the coordinate list of all nodes.

In a further technical solution of the present invention, the site images are captured by cameras; the capturing by cameras may be a capturing by a single camera or capturing by a plurality of cameras, wherein the capturing by a plurality of cameras involves the use of a triangulation method for multiple positioning and averaging to reduce the angle error of the images captured and improve the accuracy; and the images captured are calibrated by an algorithm software.

In a further technical solution of the present invention, the node information includes MAC address, ID in the network and coordinate information; and the sent pairing information includes the name of the network, the communication password, and the ID of the current node in the pairing network.

In a further technical solution of the present invention, recording the information of the current node if the node is paired successfully includes MAC address, ID, and node type in the new pairing network.

The beneficial effects of the present invention include: the method dis-turned off can realize the positioning and pairing of wireless nodes quickly and accurately; no special base station or device is required, and only an ordinary camera is needed, which can greatly reduce the application cost; through the design of combining software and hardware, the whole process is automatically controlled by software, and the pairing range can be circled manually, which improves the convenience and reduces the operation difficulty; no professional technicians are required, which reduces the labor cost of implementation; the software can perform stretching calibration and distortion calibration on the images captured by the camera, which avoids the influence caused by image distortion of the camera device and improves the positioning accuracy; a plurality of cameras can be used to obtain accurate actual coordinates through the triangulation method; and the images are captured by cameras, which is not interfered by metal objects and other wireless signals on the site, and has a wider range of applications.

### BRIEF DESCRIPTION OF THE DRAWINGS

FIG. 1 is a process chart of a method to pair and position wireless nodes by image recognition according to an embodiment of the present invention.

FIG. 2 is a site plan of four anchor points according to an embodiment of the present invention.

FIG. 3 is a diagram of images captured by cameras with four anchor points according to an embodiment of the present invention.

FIG. 4 is a site plan of coordinate calibration according to an embodiment of the present invention.

FIG. 5 is a process chart of node positioning by cameras according to an embodiment of the present invention.

FIG. 6 is a scheme diagram of positioning by dual cameras according to an embodiment of the present invention.

FIG. 7 is a scheme diagram of barrel-shaped distortion and pillow-shaped distortion according to an embodiment of the present invention.

FIG. 8 is a process chart of node pairing according to an embodiment of the present invention.

FIG. 9 is a schematic diagram of a control center software operation interface according to an embodiment of the present invention.

FIG. 10 is a schematic diagram of a camera according to an embodiment of the present invention.

FIG. 11 is a schematic diagram of a Bluetooth wireless transceiver according to an embodiment of the present invention.

FIG. 12 is a front and back sketches of a Bluetooth lamp control unit according to an embodiment of the present invention.

FIG. 13 is a front and back sketches of a Bluetooth lamp control unit PCBA according to an embodiment of the present invention.

FIG. 14 is a schematic diagram of intelligent lamps with a Bluetooth lamp control unit according to an embodiment of the present invention.

FIG. 15 is a image recognition sketch of Bluetooth intelligent lamp according to an embodiment of the present invention.

FIG. 16 is a pairing sketch of a Bluetooth intelligent lamp according to an embodiment of the present invention.

### DESCRIPTION OF THE EMBODIMENTS

Embodiments of the present invention are described in detail below. Examples of the embodiments are shown in the accompanying drawings, wherein the same or similar marking from beginning to end denotes the same or similar elements or elements with the same or similar function. The embodiments described below by reference to the accompanying drawings are exemplary and are intended for use in explaining the present invention and are not to be construed as a limitation of the present invention.

In the description of the present invention, it is to be understood that the terms “length”, “width”, “upper”, “lower”, “front”, “rear”, “left”, “right”, “vertical”, “horizontal”, “top”, “bottom”, “inside”, “outside” indicating the orientation or positional relationship are based on the orientation or positional relationship shown in the accompanying drawings, and are only for the purpose of facilitating the description of the present invention and simplifying the description. The terms shall not be understood as an indication or implication that a device or element referred to shall be constructed and operated with a particular orientation, and therefore shall not be understood as limitations on the present invention. In addition, in the description of the present invention, “a plurality of” means two or more, unless otherwise specified.

### Requirements and Goals of the Solution

The goals of the present invention include, in relation to the pairing and positioning of wireless lighting control devices, the wireless nodes can be paired quickly; the wireless nodes can be positioned quickly; manual operation and intervention can be reduced, and the construction cost and time can be reduced; common devices are used, and no special base stations or special beacons are needed; solutions meeting the requirements above can help to complete the pairing and positioning of wireless devices quickly, reduce the construction difficulty, requirements and cost; and contribute to the promotion and application of wireless IoT devices.

### Technical Solution

The wireless IoT device nodes described in the present invention may utilize several different wireless protocols. For ease of description, the following is an example of the Bluetooth wireless protocol.

### Overview of the Solution

To achieve the above goals and requirements, the present invention involves the use of the following techniques to achieve quick pairing and positioning of nodes:
Controlling the cameras and wireless nodes at the project site through the control center, and controlling the wireless nodes to turn on and off the lamps;
Continuously capturing photos and videos of the project site by the control center via cameras;
Recognizing the photos and videos to find the wireless lighting control node that is currently being turned on and off; one or more cameras can be used to capture at the site; when a single camera is used, the user can import the site plan and pair it with the multi-point stretching calibration of the plan and photos/videos to find the position of the node device, and confirm whether the node device falls within the pairing range and the position of the node device on the plan; when a plurality of cameras are used, the position and distance of the node device can be calculated by pairing the positions of a plurality of cameras and the images captured separately, and then the coordinates of the node device can be calculated.

Users can encircle the range of nodes to be paired on the plan or give the coordinate range of nodes. According to the image and video recognition results, the control center completes the pairing of the node devices in the range and gives the position of the node devices.

The following device and software therein are included in the present invention solution:
The control center is the control point for pairing and positioning, including control software, which is used to control other devices and operation processes and complete all pairing and positioning operations. The device running the control software is usually a computer. To meet the requirements of low power consumption and portability on the project site, the solution of the present invention involves the use of a Windows PC host. Other systems and hosts can be used in practical applications, such as embedded Linux. The Bluetooth component is used to send and receive Bluetooth signals and communicate with Bluetooth IoT device nodes. In the present invention, a USB Bluetooth transceiver is used as a Bluetooth component.

The camera is used to capture photos and videos of the project site. The camera communicates with the control center through USB and network.

In the process of positioning, a single camera or a plurality of cameras can be used for automatic positioning. Therefore, the implementation of the present invention is described with a single camera as an example, and the algorithm optimization solution is given in the case of a plurality of cameras.

Image recognition technology is similar to video recognition technology. The implementation of the present invention is explained with image recognition as an example.

### Bluetooth Wireless Device Node

The Bluetooth wireless device node runs embedded software and communicates with the control center through Bluetooth.

The present invention application mainly aims at the field of lighting control, and each Bluetooth wireless device node can control the turning-on or turning-off of one or more lamps. Other control functions and performances of the Bluetooth node and the lamp are not relevant to the innovation of the present invention.

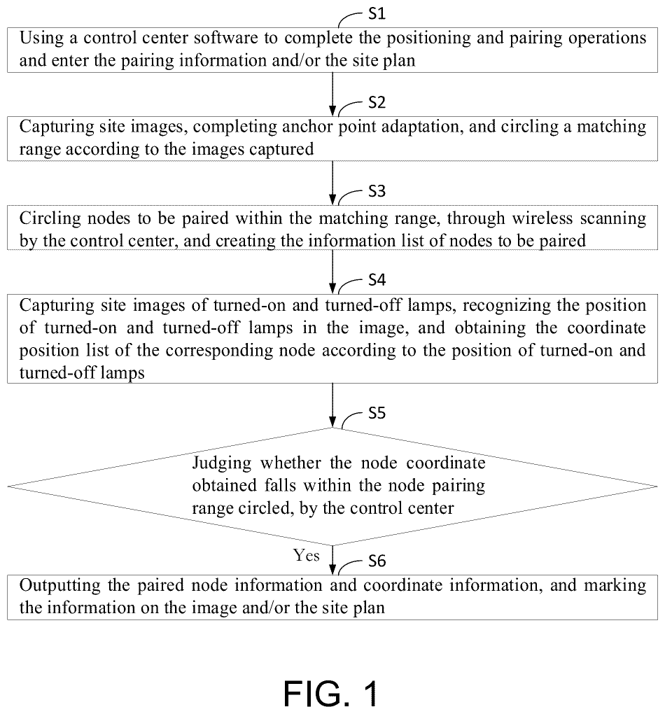

As shown in FIG. 1, a process chart of a method to pair and position wireless nodes by image recognition disclosed by the present invention, is detailed as follows:
Step S1: Using a control center software to complete the positioning and pairing operations and enter the pairing information and/or the site plan. The user starts the software of the control center, starts the positioning and pairing operations; and enters the pairing information and the site plan. The pairing information includes the name of the Bluetooth pairing network, the login password of the pairing network, and so on. The site plan is not necessary. If the site plan is entered, it should be used for pairing and outputting the plan coordinates. Otherwise, the coordinates of the camera image will be directly output.
Step S2: Capturing site images, completing anchor point adaptation, and circling a pairing range according to the images captured. A site image is captured through the camera. If the site plan is provided, mark several pairing anchor points on the image and the site plan. Usually, it is appropriate to mark 4 anchor points. At least 3 anchor points should be marked. If less than 3 anchor points are marked, it will be impossible to complete the stretching pairing of the image, impossible to mark more anchor points, or impossible to greatly increase the positioning accuracy.

Below is a description of four anchor points. The scale of coordinates is marked on the paired image. In actual applications, users can select the maximum values of coordinates X and Y.

Therefore, the marked coordinates usually include four coordinate points, including (0, 0), (0, Y-MAX), (X-MAX, 0), and (X-MAX, Y-MAX). Usually, anchor points and coordinate anchor points can be combined. If no site plan is provided, the coordinates may be marked directly on the image. Users can circle the pairing range on the site plan or directly on the image captured by the camera.

Usually, the image captured by the camera will be distorted and stretched due to the camera components, lens, placement position, and angle, and the image captured cannot be directly paired with the plan. Therefore, it is necessary to specify a series of anchor points (e.g., anchor point 1, 2, 3, or 4) to pair between the plan and the image captured by the camera, as shown in FIG. 3.

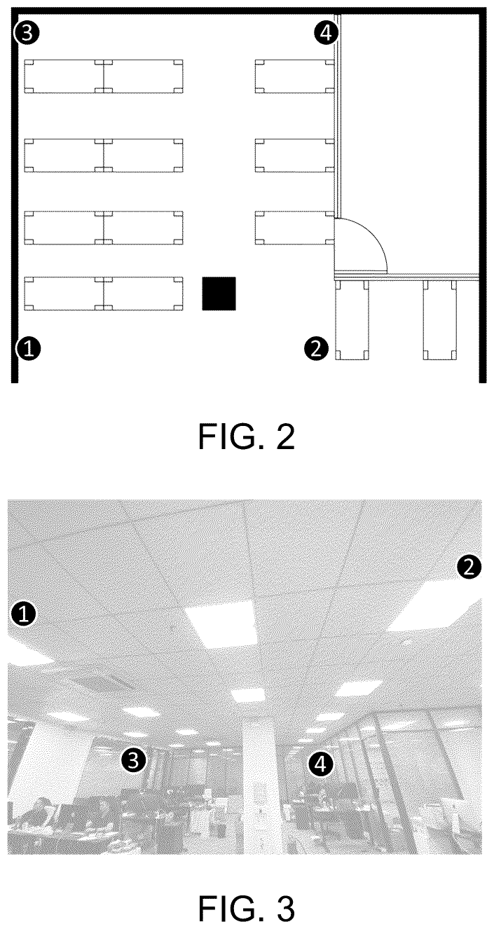

The control center software can stretch and calibrate the image according to the pairing anchor points (e.g., anchor point 1, 2, 3, or 4) so that the image can be accurately paired with the site plan, as shown in FIG. 2. If no site plan is provided, this step may be skipped.
Step S3: Circling nodes to be paired within the pairing range, through wireless scanning by the control center, and creating the information list of nodes to be paired. The control center scans the nearby Bluetooth nodes to be paired through the Bluetooth antenna; and creates the information list of Bluetooth nodes to be paired. The list contains the MAC address and device type (Profile that can provide services) of all Bluetooth nodes.
Step S4: Capturing site images of turned-on and turned-off lamps, recognizing the position of turned-on and turned-off lamps in the image, and obtaining the coordinate position list of the corresponding node according to the position of turned-on and turned-off lamps. The control center software controls the Bluetooth nodes to turn on and turn off the connected lamps one by one through the Bluetooth antenna, captures the site image through the camera, recognizes the position of the lamps being turned on and turned off in the image, to judge the position of the Bluetooth nodes currently being controlled. The coordinate position of the Bluetooth node is obtained according to the recognized position.

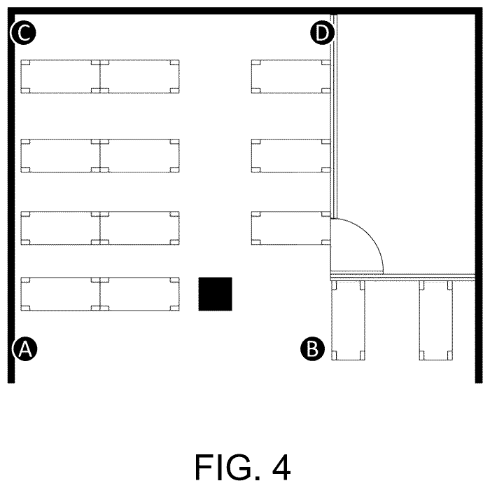

Users can set the X-axis maximum value X-MAX and the Y-axis maximum value Y-MAX of the coordinates; and set the calibration points of coordinates on the image: A (0,0), B (X-MAX, 0), C (0, Y-MAX), and D (X-MAX, Y-MAX). If the site plan is provided, the coordinate points (e.g., point A, point B, point C, or point D) are marked on the plan. As shown in FIG. 4, if no site plan is provided, the coordinate points can be marked directly on the image.

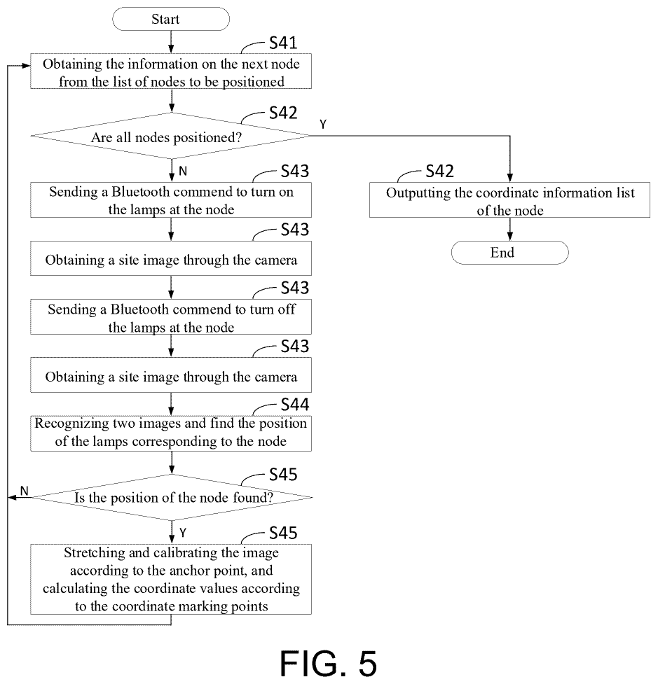

The process of node positioning by a camera is shown in FIG. 5. As shown in FIG. 5, a process chart, the process of node positioning by a camera is as follows:
Step S41: Obtaining the information on the next node from the list of nodes to be positioned; the information of the next node is obtained from the list of nodes to be positioned and paired. If all nodes are positioned, the coordinate information list corresponding to the node will be output.
Step S42: Judging whether the Bluetooth nodes to be positioned are all positioned; if yes, outputting the coordinate information list corresponding to the Bluetooth nodes; and if no, executing the next step.
Step S43: Sending the command of turning on and turning off lamps from a designated Bluetooth node to turn on and turn off lamps at the Bluetooth node, and capturing site images of turned-on lamps and site images of turned-off lamps. For the specified node, the command to turn on the lamps is sent through the Bluetooth antenna to turn on the lamps controlled by the node. A site image is captured through the camera. For the specified node, the command to turn off the lamps is sent through the Bluetooth antenna to turn off the lamps controlled by the node. A site image is captured through the camera.
Step S44: Recognizing the site images of turned-on lamps and site images of turned-off lamps obtained from the Bluetooth node and obtaining the position of lamps corresponding to the Bluetooth node. The two images captured are recognized to find the position of the lamps corresponding to the node. The process of turning on the lamps, capturing the image, turning off the lamps, capturing the image, and recognizing the image can be repeated many times, to avoid the problem that the site environment may cause image recognition failure.
Step S45: Judging whether the position of lamps corresponding to the Bluetooth node falls within the Bluetooth node pairing range; if no, determining that the Bluetooth node does not fall within the pairing range and executing step S41; if yes, stretching and calibrating the image according to the pairing anchor points, calculating the coordinate position of the node on the calibrated image, recording the corresponding information and executing step S41. If the node is not found through image recognition, it means that the node may not be in the image range. The next node is taken to continue the positioning operation. If a node is found through image recognition, the image is stretched and calibrated according to the pairing anchor point, the coordinate position of the node is calculated on the calibrated image, and the corresponding information is recorded. Then the next node is taken to continue the positioning operation.

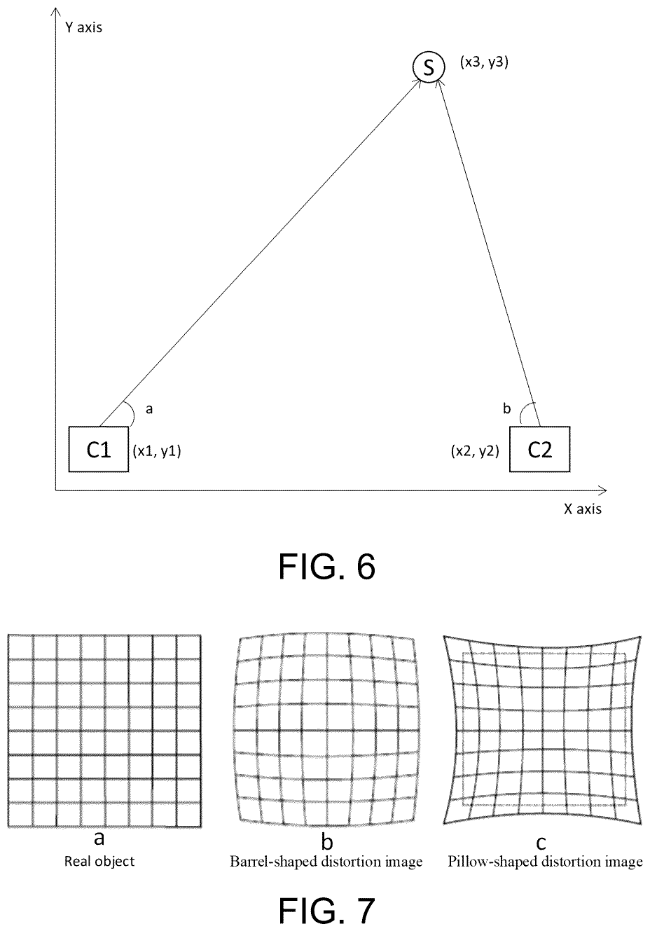

For positioning by a plurality of cameras, on the site, images can be captured by a plurality of cameras to obtain more accurate coordinate position and actual distance information. With two cameras as an example, referring to FIG. 6, wherein C1 is a single camera with the coordinate position on the plane of (x1, y1); C2 is a single camera with the coordinate position on the plane of (x2, y2); and S is the position of the lamps controlled by the wireless node, with a corresponding coordinate of (x3, y3), which is a goal to be solved by the solution. The two cameras are calibrated horizontally and are facing a certain direction. In the present invention, the camera is calibrated to face the positive direction of axis-Y. In the process of node positioning, images are captured and recognized by two cameras, C1 and C2, respectively, to find the position of S in the image. In the image of C1, the deviation between S and the central angle of the image is identified, and the angle a between the C1-S line and axis-X is obtained. In the image of C2, the deviation between S and the central angle of the image is identified, and the angle b between the C2-S line and axis-X is obtained. According to the known coordinates of C1 (x1, y1) and C2 (x2, y2), and the angles a and b, the coordinates (x3, y3) of S can be calculated. During the calculation, the actual distance between the two cameras C1 and C2 is entered, and the actual distance and coordinates of S can be further obtained.

When a plurality of cameras are used, the triangulation method can be used for multiple positioning and then the average value is taken to reduce the angle error of the images captured by the cameras and improve the positioning accuracy.

To simplify the calculation, in the actual construction test, two cameras should be on the same parallel line of axis-X or axis-Y. For example, y1=y2 or x1=x2 of cameras C1 and C2 are required.

Taking y1=y2 as an example, the above calculation results are as follows:

$$x 3 = ( x 1 * tan ( a ) + x 2 * tan ( b ) ) / ( tan ( a ) + tan ( b ) ) \\ y 3 = tan ( a ) * ( ( x 1 * tan ( a ) + x 2 * tan ( b ) ) // ( tan ( a ) + tan ( b ) ) - x 1 ) + y 1 ;$$

Due to the components of the camera, including the lens and photosensitive settings, there is usually a certain barrel-shaped distortion or pillow-shaped distortion in the images captured, as the barrel-shaped distortion image b and the pillow-shaped distortion image c of the real object a shown in FIG. 7. Therefore, to obtain the accurate angle, the images captured should be calibrated. Distortion calibration is related to the parameters of the specific camera and there are mature available software algorithms, which will not be described in the present invention.
Step S5: Judging whether the Bluetooth node coordinate obtained falls within the node pairing range circled, by the control center; if yes, sending the pairing information to the Bluetooth node to complete pairing; and if no, deleting the coordinate of the current Bluetooth node from the list. The control center software checks whether the node coordinates fall within the pairing range circled one by one; if yes, sends the pairing information to the Bluetooth node to complete the pairing; and records the pairing results and coordinates of the node until all nodes are checked and paired.

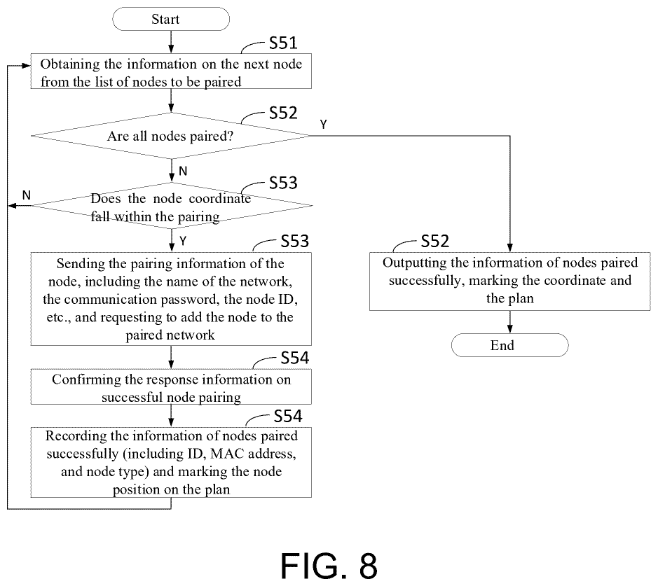

As shown in FIG. 8, a process chart, the process of node pairing is as follows:
Step S51: Obtaining the information on the next Bluetooth node from the list of Bluetooth nodes to be paired. The information on the next node is obtained from the list of nodes to be paired.
Step S52: Judging whether the Bluetooth nodes in the list are all paired; if yes, outputting the information on the Bluetooth nodes that are paired successfully, marking them on the image and entering the marking points on the plan; and if no, executing the next step. If all nodes are paired successfully, the information on nodes that are paired successfully will be output, including the MAC address of the node, the ID in the network, the coordinate information, and the marking points on the plan (if the plan is entered).
Step S53: Judging whether the coordinate of the current Bluetooth node falls within the pairing range; if yes, sending the pairing information to the current Bluetooth node, adding the node to a new pairing network, and executing the next step; and if no, skipping the current node and executing step S51. For the current node, the coordinate is checked to see whether it falls within the pairing range. The node should be skipped if no. The pairing information should be sent to the current node, including the name of the network to be added for pairing, the communication password, and the ID of the node in the pairing network, and the pairing command should be sent immediately. After receiving the command of immediate pairing, the node exits the factory-set network and joins the new pairing network.
Step S54: Searching the current node in the new pairing network and judging whether the node is paired successfully; and if yes, recording the information on the current node. The current node is found in the new pairing network and whether the current node is paired successfully is confirmed. If yes, the information of the current node is recorded, including the MAC address of the node, ID in the new pairing network, node type, etc. S541: Judging whether a site plan is entered; if yes, marking the position of the Bluetooth node on the plan, and proceeding the pairing process of the next Bluetooth node; and if no, skipping the process. If the plan is entered, the position of the node is marked on the plan. Then, the pairing process of the next node starts.
Step S6: Outputting the paired Bluetooth node information and coordinate information, and marking the information on the image and/or the site plan. Finally, the paired node information and coordinate information are output, as well as the marking of the node on the site plan, or the image.

### Overview of the Implementation Scheme

According to the technical solution of the present invention, a laptop is selected as the control center in the implementation.

For Bluetooth devices, including the Bluetooth wireless transceiver in the control center and the control node of Bluetooth lamps, the main chip is selected from Telink TLSR8250 Bluetooth chips. The chip integrates wireless transceiver functions, has a 32M main frequency MCU, and has built-in operating memory and storage flash memory. The chip supports BLE MESH wireless communication technology and is capable of supporting up to 255 devices online simultaneously within a network. It is one of the preferred solutions for wireless smart devices and is widely used in the market.

The camera is selected from HIKVISION E11 720P cameras.

In actual applications, different solutions may be used for the control center, the wireless device, and the camera, without affecting the innovation and effect of the present invention.

### Control Center

### Control Center Software

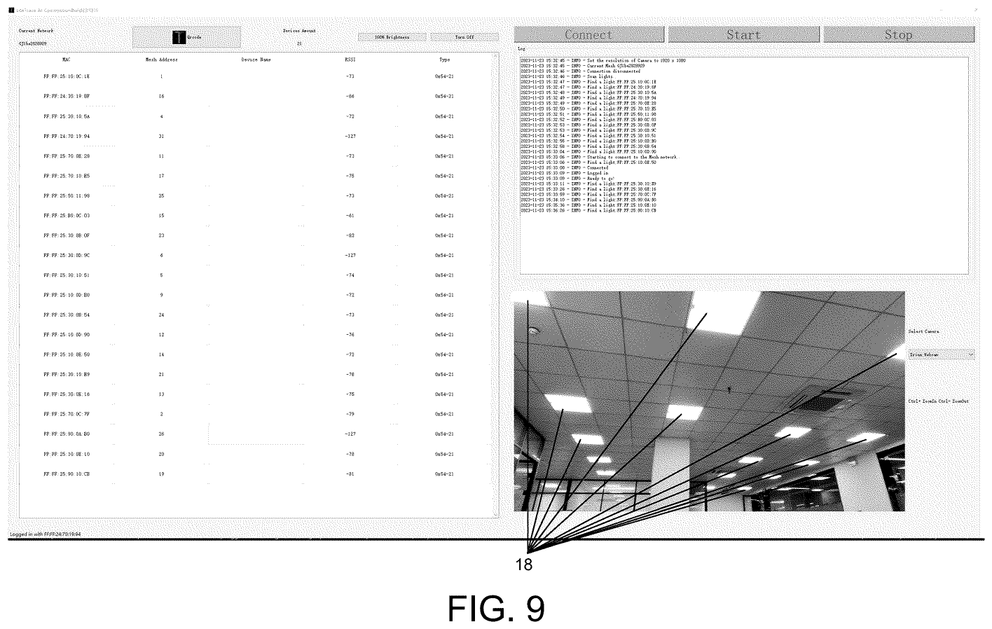

The operation interface of the control center software is shown in FIG. 9. The interface of the control center software includes a list of node information on the left, including the MAC address of the node, ID after pairing, device name, RSSI, device type, etc.; a software work log record on the upper right part, which shows the information of software work to the operators; a display of videos and images captured by cameras on the lower right part; and a display of the node information after positioning and pairing.

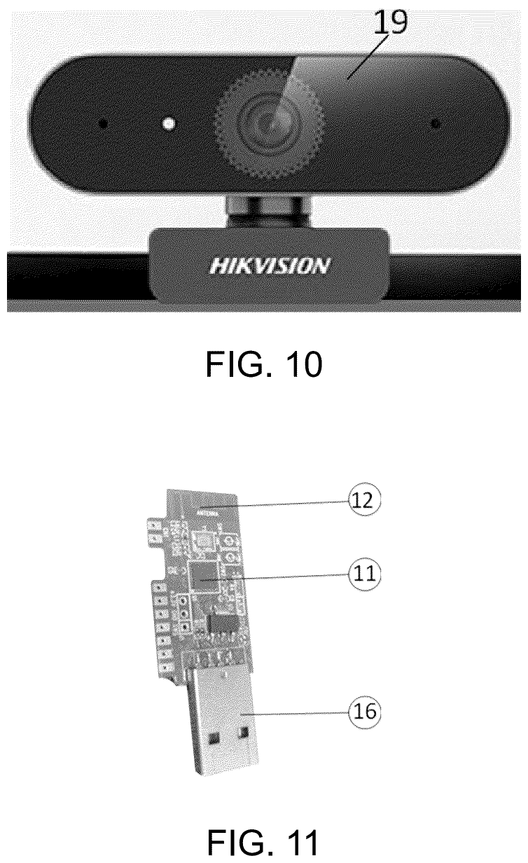

In the implementation of the solution, the camera is selected from HIKVISION E11 720P cameras 19, as shown in FIG. 10. In actual applications, cameras of different brands and interfaces, or a mobile phone camera may be selected. Different cameras do not affect the innovation and function of the present invention.

### Bluetooth Wireless Transceiver

In the implementation scheme, for the Bluetooth wireless transceiver in the control center, the main chip is selected from Telink TLSR8250 Bluetooth chips, the USB interface is used to communicate with the computer of the control center, and the onboard antenna is used to send and receive Bluetooth wireless signals, as shown in FIG. 11:

As shown in FIG. 11, the Bluetooth wireless transceiver includes the following main components:
Component 11 is a TLSR8250 Bluetooth chip, which contains a Bluetooth transceiver and communication software.
Component 12 is an onboard Bluetooth antenna.
Component 16 is a USB interface, which is used for power supply and communication with the control center.

### Wireless Device Hardware

### Bluetooth Lamp Control Unit

In the implementation scheme, for the Bluetooth lamp control unit, the main chip is selected from Telink TLSR8250 Bluetooth chips, a DC12V power supply is used, and the lamps are controlled by 0-10V dimmer output.

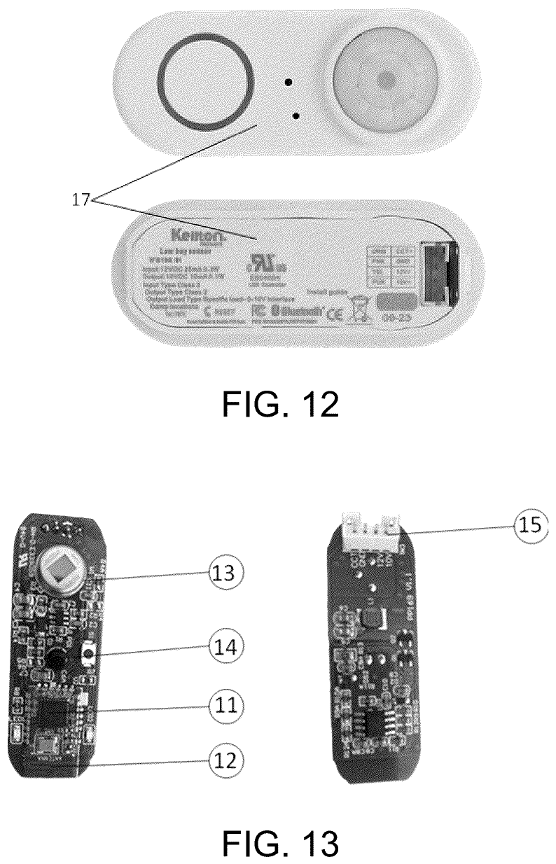

The appearance and PCBA of the Bluetooth lamp control unit are shown in FIG. 12 and FIG. 13.

As shown in FIG. 13, the Bluetooth lamp control unit includes the following main components:
Component 11 is a TLSR8250 Bluetooth chip, which includes Bluetooth transceiver and communication software and intelligent lamp control software.
Component 12 is an onboard Bluetooth antenna.
Component 13 is a passive infrared (PIR) body sensor.
Component 14 is a light sensor.
Component 15 is an interface, which includes a DC 12V supply input and 0-10V dimmer output terminals.

Among them, the functions of the body sensor and the light sensor are not related to the present invention and do not affect the functions and effects of the present invention, which will not be described herein.

Intelligent Lamps with a Bluetooth Lamp Control Unit

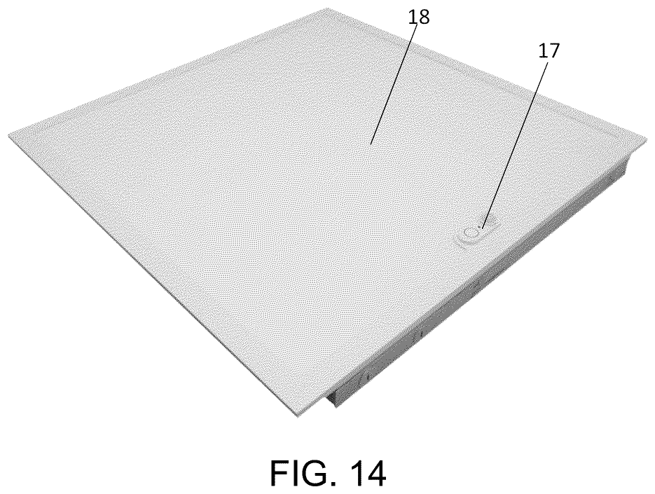

In the implementation scheme, intelligent lamps 18 are used and installed on the Bluetooth lamp control unit 17, as shown in FIG. 14. Intelligent lamps are provided with a DC12V power supply output interface and 0-10V dimmer input interface, and the installation position of the Bluetooth lamp control unit is reserved. As shown in FIG. 14, intelligent lamps can operate with the Bluetooth lamp control unit and can be turned on, turned off, or dimmed through the Bluetooth lamp control unit.

The specific design and function of the intelligent lamps are not related to the present invention and do not affect the functions and effects of the present invention, which will not be described herein.

### Evaluation of Test Results

The test process is shown in FIG. 9. It is a screenshot of the control center software starting up and working.

As shown in FIG. 9, the control center software scans for the Bluetooth lamp control unit 17, including the MAC address of the node, type, and more. The control center software can capture the video and image of the site through the camera.

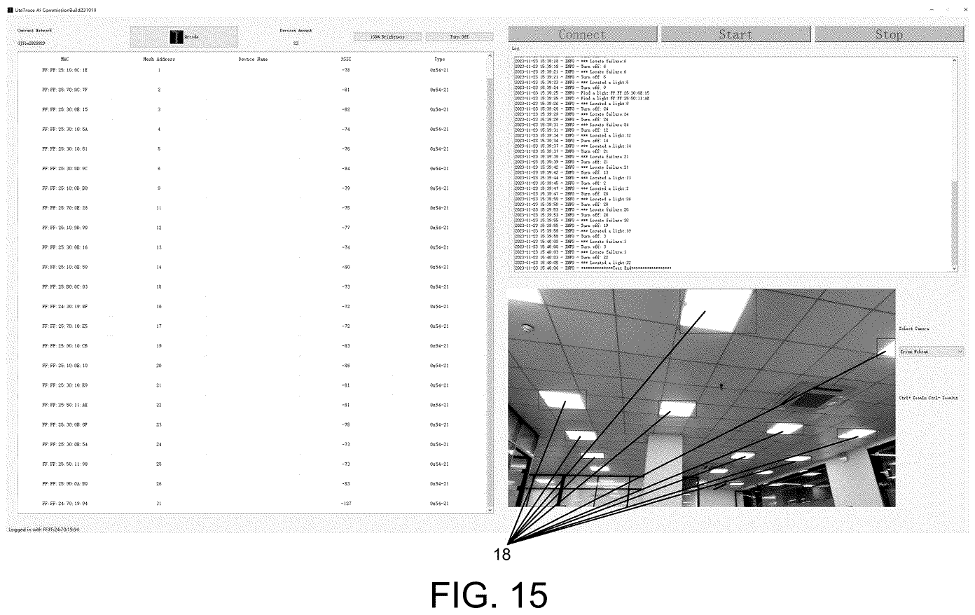

As shown in FIG. 15, the control center software recognizes the images captured through the Bluetooth lamp control unit 17 and finds the position of the lamps controlled by the Bluetooth node.

As shown in FIG. 15, the control center software finds the position of the Bluetooth intelligent lamps and marks them by a box on the image.

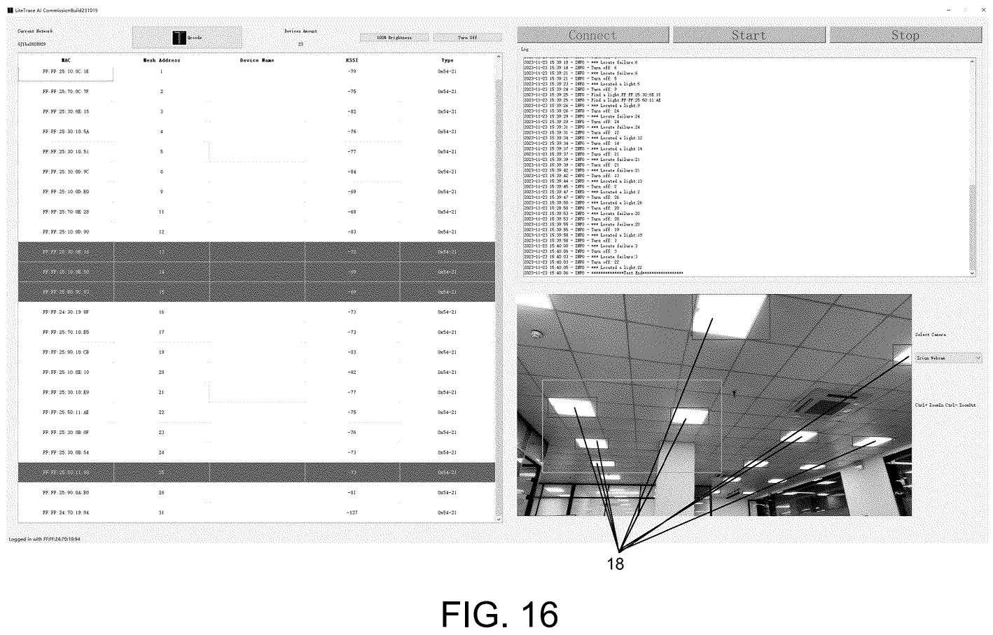

As shown in FIG. 16, the user checks the lamps to be paired by a box on the control center software. The control center highlights the node corresponding to the lamps selected and adds it to the pairing network. As shown in FIG. 16, the control center software completed the pairing of the node selected and highlighted it.

According to the test, through video and image recognition, wireless nodes in the IoT can be quickly positioned and paired. On average, it only takes 3-5 seconds to complete the positioning and pairing operations for a node. The operation speed is much faster than the common schemes in the market at present. Moreover, the software operation is simple and the device cost is low. The coordinate position of that device can be obtained very accurately. It completely achieves the design goal of the present invention and indicates excellent technical and market feasibility.

The present invention further aims to provide A system to pair and position wireless nodes by image recognition, wherein the system to pair and position wireless nodes by image recognition includes
a module to start the entering, for using a control center software to complete the positioning and pairing operations and enter the pairing information and/or the site plan;
a module to circle the range, for capturing site images, completing anchor point adaptation, and circling a pairing range according to the images captured;
a module to scan the node list, for circling nodes to be paired within the pairing range, through wireless scanning by the control center, and creating the information list of nodes to be paired;
a module to obtain the node coordinate, for capturing site images of turned-on and turned-off lamps, recognizing the position of turned-on and turned-off lamps in the image, and obtaining the coordinate position list of the corresponding node according to the position of turned-on and turned-off lamps;
a module to judge, for judging whether the node coordinate obtained falls within the node pairing range circled, by the control center; if yes, sending the pairing information to the node to complete pairing; and if no, deleting the coordinate of the current node from the list; and
a module to mark, for outputting the paired node information and coordinate information, and marking the information on the image and/or the site plan.

The module to obtain the node coordinate further includes
a unit to obtain the next node, for obtaining the information on the next node from the list of nodes to be positioned; p1 a unit to judge the positioning, for judging whether the nodes to be positioned are all positioned; if yes, outputting the coordinate information list corresponding to the nodes; and if no, executing the unit to obtain the images of turned on and turned off lamps;
a unit to obtain the images of turned-on and turned-off lamps, for sending the command of turning on and turning off lamps from a designated node to turn on and turn off lamps at the node, and capturing site images of turned-on lamps and site images of turned off lamps;
a unit to obtain the position recognized, for recognizing the site images of turned-on lamps and site images of turned-off lamps obtained from the node and obtaining the position of lamps corresponding to the node; and
a unit to judge the node position, for judging whether the position of lamps corresponding to the node falls within the node pairing range; if no, determining that the node does not fall within the pairing range and executing the unit to obtain the next node; if yes, stretching and calibrating the image according to the pairing anchor points, calculating the coordinate position of the node on the calibrated image, recording the corresponding information and executing the unit to obtain the next node.

The module to judge further includes
a unit to obtain the node information, for obtaining the information on the next node from the list of nodes to be paired;
a unit to complete pairing, for judging whether all nodes in the list are all paired; if yes, outputting the information on the nodes that are paired successfully, marking them on the image and entering the marking points on the plan; and if no, executing the unit to judge the coordinate point;
a unit to judge the coordinate point, for judging whether the coordinate of the current node falls within the pairing range; if yes, sending the pairing information to the current node, adding the node to a new pairing network, and executing the unit to record the judgment; and if no, skipping the current node and executing the unit to obtain the node information; and
a unit to record the judgment, for searching the current node in the new pairing network and judging whether the node is paired successfully; and if yes, recording the information on the current node.

The unit to record the judgment further includes
a unit to judge the site plan entering, for judging whether a site plan is entered; if yes, marking the position of the node on the plan, and proceeding the pairing process of the next node; and if no, skipping the process.

The pairing information entered in the module to start the entering includes the name of the pairing network and the login password of the pairing network; and the entered information includes a site plan for subsequent pairing and output of the coordinate of the site plan.

The module to circle the range further includes
a unit to mark the anchor points, for marking several paired anchor points on the image and/or the site plan, respectively;
a unit to mark the scale, for marking the scale of the coordinates on the paired image and/or the site plan; and
a unit to circle the pairing range, for combining the anchor points and the coordinate positioning points, and circling the pairing range on the site plan and/or the image.

The control center in the module to obtain the node coordinate recognizes the position of nodes one by one and outputs the coordinate list of all nodes.

The site images are captured by cameras; the capturing by cameras may be a capturing by a single camera or capturing by a plurality of cameras, wherein the capturing by a plurality of cameras involves the use of a triangulation method for multiple positioning and averaging to reduce the angle error of the images captured and improve the accuracy; and the images captured are calibrated by an algorithm software.

The node information mentioned includes MAC address, ID in the network and coordinate information; and the sending the pairing information includes the name of the network, the communication password, and the ID of the current node in the pairing network. Recording the information of the current node if the node is paired successfully includes MAC address, ID, and node type in the new pairing network.

The foregoing are merely preferred embodiments of the present invention and are not intended to limit the present invention. Any modifications, equivalent substitutions, improvements, etc. made within the spirit and principles of the present invention shall be included in the scope of protection of the present invention.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A method to pair and position wireless nodes by image recognition, wherein the method to pair and position wireless nodes by image recognition includes the following steps:
step S1: using a control center software to complete positioning and pairing operations and entering pairing information or a site plan;
step S2: capturing site images, completing anchor point adaptation, and circling a pairing range according to the site images captured;
step S3: circling nodes to be paired within the pairing range, through wireless scanning by a control center, and creating an information list of nodes to be paired;
step S4: capturing site images of turned-on and turned-off lamps, recognizing a position of turned-on and turned-off lamps in an image, and obtaining a coordinate position list of a corresponding node according to the position of turned-on and turned-off lamps;
step S5: judging whether a node's coordinate obtained falls within the pairing range circled, by the control center; if yes, sending the pairing information to the node to complete pairing; and
if no, deleting the coordinate of the current node from the coordinate position list; and
step S6: outputting paired node information and coordinate information, and marking information on the image or the site plan.

2. The method to pair and position wireless nodes by image recognition according to claim 1, wherein the step S4 includes the following steps:
step S41: obtaining the information on a next node from a list of nodes to be positioned;
step S42: judging whether the nodes to be positioned are all positioned; if yes, outputting a coordinate information list corresponding to the nodes; and if no, executing step S43;
step S43: sending a command of turning on and turning off lamps from a designated node to turn on and turn off lamps at the node, and capturing site images of turned-on lamps and site images of turned-off lamps;
step S44: recognizing the site images of turned-on lamps and the site images of turned-off lamps obtained from the node and obtaining a position of lamps corresponding to the node; and
step S45: judging whether the position of lamps corresponding to the node falls within the pairing range; if no, determining that the node is not within the pairing range and executing step S41; if yes, stretching and calibrating the image according to pairing anchor points, calculating a coordinate position of the node on the calibrated image, recording the corresponding information, and executing step S41.

3. The method to pair and position wireless nodes by image recognition according to claim 2, wherein the step S5 includes the following steps:
step S51: obtaining the information on the next node from list of nodes to be paired;
step S52: judging whether all nodes in the list of nodes to be paired are all paired; if yes, outputting the information on the nodes that are paired successfully, marking them on the image and entering marking points on the site plan; and if no, executing the step S53;
step S53: judging whether the coordinate of the current node falls within the pairing range; if yes, sending the pairing information to the current node, adding the node to a new pairing network, and executing the step S54; and if no, skipping the current node and executing step S51; and
step S54: searching the current node in the new pairing network and judging whether the node is paired successfully; and if yes, recording the information on the current node.

4. The method to pair and position wireless nodes by image recognition according to claim 3, wherein the step S54 includes the following steps:
step S541: judging whether the site plan is entered; if yes, marking the coordinate position of the node on the site plan, and proceeding a pairing process of the next node; and if no, skipping the pairing process if the site plan is not entered.

5. The method to pair and position wireless nodes by image recognition according to claim 4, wherein the pairing information entered in the step S1 includes a name of the pairing network and a login password of the pairing network; and entered information includes the site plan for subsequent pairing and output of a coordinate of the site plan.

6. The method to pair and position wireless nodes by image recognition according to claim 5, wherein the step S2 includes the following steps:
step S21: marking several paired anchor points on the image or the site plan, respectively;
step S22: marking a scale of coordinates on paired image or the site plan; and
step S23: combining the anchor points and coordinate positioning points, and circling the pairing range on the site plan or the image.

7. The method to pair and position wireless nodes by image recognition according to claim 6, wherein the control center in the step S4 recognizes a position of nodes one by one and outputs the coordinate position list of all nodes.

8. The method to pair and position wireless nodes by image recognition according to claim 7, wherein the site images are captured by cameras, the capturing by cameras may be a capturing by a single camera or capturing by a plurality of cameras, wherein the capturing by the plurality of cameras involves a use of a triangulation method for multiple positioning and averaging to reduce an angle error of the site images captured and improve an accuracy; and the site images captured are calibrated by an algorithm software.

9. The method to pair and position wireless nodes by image recognition according to claim 8, wherein the paired node information includes a media access control (MAC) address, an identity (ID) in the pairing network and the coordinate information; and the sending the pairing information includes the name of the paring network, the login password, and the ID of the current node in the pairing network.

10. The method to pair and position wireless nodes by image recognition according to claim 9, wherein recording the information of the current node if the node is paired successfully includes the MAC address, the ID, and node type in the new pairing network.

11. A system to pair and position wireless nodes by image recognition, wherein the system to pair and position wireless nodes by image recognition includes
a module to start an entering, for using a control center software to complete positioning and pairing operations and enter pairing information or a site plan;
a module to circle a range, for capturing site images, completing anchor point adaptation, and circling a pairing range according to the site images captured;
a module to scan a node list, for circling nodes to be paired within the pairing range, through wireless scanning by a control center, and creating an information list of nodes to be paired;
a module to obtain a node coordinate, for capturing site images of turned-on and turned-off lamps, recognizing a position of turned-on and turned-off lamps in an image, and obtaining a coordinate position list of a corresponding node according to the positions of turned-on and turned-off lamps;
a module to judge, for judging whether a node's coordinate obtained falls within the pairing range circled, by the control center; sending the pairing information to the node to complete pairing if the node's coordinate falls within the pairing range circled; and deleting the coordinate of the current node from the coordinate position list if the node's coordinate does not fall within the pairing range circled; and
a module to mark, for outputting paired node information and coordinate information, and marking information on the image or the site plan.

12. The system to pair and position wireless nodes by image recognition according to claim 11, wherein the module to obtain the node coordinate further includes
a unit to obtain a next node, for obtaining the information on the next node from a list of nodes to be positioned;
a unit to judge a positioning, for judging whether the nodes to be positioned are all positioned;
outputting a coordinate information list corresponding to the nodes to be positioned if the nodes to be positioned are all positioned; and executing the unit to obtain images of turned on and turned off lamps if the nodes to be positioned are not positioned;
a unit to obtain the images of turned-on and turned-off lamps, for sending a command of turning on and turning off lamps from a designated node to turn on and turn off lamps at the node, and capturing site images of turned-on lamps and site images of turned off lamps;
a unit to obtain the position recognized, for recognizing the site images of turned-on lamps and the site images of turned-off lamps obtained from the node and obtaining a position of lamps corresponding to the node; and
a unit to judge the node's position, for judging whether the position of lamps corresponding to the node falls within the pairing range; if no, determining that the node does not fall within the pairing range and executing the unit to obtain the next node; if yes, stretching and calibrating the image according to pairing anchor points, calculating a coordinate position of the node on the calibrated image, recording the corresponding information and executing the unit to obtain the next node.

13. The system to pair and position wireless nodes by image recognition according to claim 12, wherein the module to judge further includes
a unit to obtain the node information, for obtaining the information on the next node from a list of nodes to be paired;
a unit to complete pairing, for judging whether all nodes in the list of nodes to be paired are all paired; if yes, outputting the information on the nodes that are paired successfully, marking them on the image and entering marking points on the site plan; and if no, executing the unit to judge a coordinate point;
a unit to judge the coordinate point, for judging whether the coordinate of the current node falls within the pairing range; if yes, sending the pairing information to the current node, adding the node to a new pairing network, and executing a unit to record a judgment; and if no, skipping the current node and executing the unit to obtain the node information; and
the unit to record the judgment, for searching the current node in the new pairing network and judging whether the node is paired successfully; and if yes, recording the information on the current node.

14. The system to pair and position wireless nodes by image recognition according to claim 13, wherein the unit to record the judgment further includes
a unit to judge a site plan entering, for judging whether the site plan is entered; if yes, marking the coordinate position of the node on the site plan, and proceeding a pairing process of the next node; and if no, skipping the process.

15. The system to pair and position wireless nodes by image recognition according to claim 14, wherein the pairing information entered in the module to start the entering includes a name of the pairing network and a login password of the pairing network; and entered information includes the site plan for subsequent pairing and output of a coordinate of the site plan.

16. The system to pair and position wireless nodes by image recognition according to claim 15, wherein the module to circle the range further includes
a unit to mark anchor points, for marking several paired anchor points on the image or the site plan, respectively;
a unit to mark a scale, for marking the scale of coordinates on paired image or the site plan; and
a unit to circle the pairing range, for combining the anchor points and coordinate positioning points, and circling the pairing range on the site plan or the image.

17. The system to pair and position wireless nodes by image recognition according to claim 16, wherein the control center in the module to obtain the node coordinate recognizes a position of nodes one by one and outputs the coordinate position list of all nodes.

18. The system to pair and position wireless nodes by image recognition according to claim 17, wherein the site images are captured by cameras; the capturing by cameras may be a capturing by a single camera or capturing by a plurality of cameras, wherein the capturing by the plurality of cameras involves a use of a triangulation method for multiple positioning and averaging to reduce an angle error of the site images captured and improve an accuracy; and the site images captured are calibrated by an algorithm software.

19. The system to pair and position wireless nodes by image recognition according to claim 18, wherein the paired node information includes a media access control (MAC) address, an identity (ID) in the paring network and the coordinate information; and the sending the pairing information includes the name of the paring network, the login password, and the ID of the current node in the pairing network.

20. The system to pair and position wireless nodes by image recognition according to claim 19, wherein recording the information of the current node if the node is paired successfully includes the MAC address, the ID, and node type in the new pairing network.
